(19) United States
(12) Patent Application Publication
(10) Pub. No.: US 2007/0044022 A1
(43) Pub. Date: Feb. 22, 2007

(54) Method, unit and system for outputting data

(76) Inventors: Hyun Kyung Shin, Pleasanton, CA (US); Pushkar Singh, Fremont, CA (US)

Correspondence Address: EDELL, SHAPIRO & FINNAN, LLC, 1901 RESEARCH BLVD., SUITE 400, ROCKVILLE, MD, 20850, US

(21) Appl. No.: 11/499,868

(22) Filed: Aug. 7, 2006

Related U.S. Application Data
(63) Continuation of application No. PCT/EP05/00993, filed on Feb. 1, 2005.

(51) Int. Cl. G06F 3/00

(52) U.S. Cl. 715/700

(57) ABSTRACT

Data is output from a sending unit to a receiving unit via a common description language. The sending unit defines a user interface to be output to a number of receiving units, whereby each receiving unit may have different output capabilities, specific to the receiving unit.

### CROSS REFERENCE TO RELATED APPLICATIONS

This application is a continuation of International Application No. PCT/EP2005/000993, filed Feb. 1, 2005, and entitled “Method, Arrangement and System for Outputting Data,” which claims priority from U.S. Provisional Patent Application No. 60/542,194, filed on Feb. 5, 2004, and entitled “Method, Arrangement and System for Outputting Data,” the entire contents of which are hereby incorporated by reference.

### FIELD OF THE INVENTION

The invention relates to a method for outputting data available to a sending unit on a receiving unit using a common description language. The method affects a client/server system, in which the server acting as the sending unit defines a user interface to be output on a number of clients acting as the receiving units, whereby each client may have different output capabilities, specific to the client.

### BACKGROUND

Up to now the most common way of outputting data on a number of clients with specific output capabilities was simply to create on the server side different formats for the output for each specialized type of client. For example, a server provides a hypertext mark-up language (HTML) document describing a page to be output on a PC. On the PC a web browser only displays the received HTML document. If another client is to be used, for example a mobile device with a smaller screens like a personal digital assistant (PDA), which employs for example the wireless application protocol (WAP) for displaying information, the server has to provide a different description of the same information, which takes account of the smaller screen size and follows the encoding rules of the used standard, i.e., the WAP specification. For devices using a messaging service, such as the short message service (SMS) of mobile phone networks, the server has to provide yet another description of the same information to be displayed.

Recent programming techniques like Java servlets have helped to make the production of different output formats easier by providing standard methods for the creation of output according to the format of common client types. Nevertheless the fact remains that multiple output formats, i.e., instructions on how to present the output data, have to be developed, maintained and provided by the server. Especially the maintenance of the specified output formats is a burden for the programmer as the introduction of new or revised client types might require to change the source code of the application program. In addition, the programmer has to code the output data in a format specific to the used client or protocol, i.e., he or she needs additional knowledge about these client types and protocols in addition to the required knowledge of the application domain and programming environment, which is another burden on the programmer providing the application.

Other methods exchange only the data to be output between the client and the server, e.g., text to be presented to the user, but no output format information, i.e., information on how to present the data to a user. This is often done using the extensible mark-up language (XML) as standard for the data exchange.

In this case, the client itself must be aware of how to present the received output data. For example, a client that only receives a list of values needs to know how the values form the available options of a particular choice and also how to present such a choice to a user. For example, it must be aware if they are independent of each other, i.e., if they form the entries of a list, of which none, one or many entries can be chosen, or if they are exclusive, i.e., if they form the entries of a list, of which exactly one must be chosen at any one time. Since in this approach such information is not provided in the data sent out by the server, large parts of the output format must be provided by the client.

However, this output format is both dependant on the application which provides the data to be output and the client itself. Thus, each time a new application is developed, a new output format must be developed for each client. Using this approach it will be necessary to implement and install new output formats on the client, whenever new or revised applications become available on the server. This is ineffective and may be infeasible, if the clients are not part of a managed environment, i.e., if they are owned by individual users.

In summary, both previously-described methods lack the flexibility to output data of an arbitrary application on a variety of clients, each of which may have different output capabilities, specific to the client.

### SUMMARY

The invention provides a flexible method for outputting data available to a sending unit on a variety of receiving units with different means of outputting data, specific to the receiving unit.

The term unit is referred to throughout this document to identify a specific function of the method or specific component of the system. Alternatively, the term unit can also refer to a collection of functions that perform the specific function or a collection of components that are comprised in the specific component. Likewise, the collection of components could be physically and/or electrically connected or alternatively could be connected via a network, e.g., local area network (LAN), wide area network (WAN) or the internet.

The inventive method makes use of a description language, which contains symbols for the description of abstract output elements for the output of data. This language is known to the sending and to the receiving unit. The sending unit maps output data provided to it to abstract output elements. These elements are encoded to form an output specification using symbols from the abstract language. The output specification is transmitted to a receiving unit. The receiving unit decodes the transmitted output specification into the abstract output elements. In addition, the receiving unit has access to output components which are specific to the output capabilities of the receiving unit. The receiving unit maps the decoded abstract output elements to the output components. In a last procedure the mapped output components are output by the receiving unit.

According to the invention, there are the two mapping processes, which map the output data to abstract output elements at the sending unit and map the abstract output elements to output components at the receiving unit respectively. The first mapping provides the independence of the sending unit from the used receiving unit. The latter mapping provides the independence of the receiving unit from the sending unit providing the output data. Thus the two mappings into and from a common abstract language achieve a higher degree of flexibility of the inventive method.

In a preferred embodiment the description language also provides abstract elements, which contain at least one input parameter. In order to enable a feedback from the receiving unit, the inventive method also includes the following procedures. Input parameters of the abstract output elements are mapped to input components provided by the receiving unit, which are specific to the input capabilities of that receiving unit. Values acquired by the input components of the receiving unit are used to update the input parameters of the abstract output elements. Through a pre-defined event, such as pressing a confirmation button, a feedback mechanism is triggered. The abstract output elements containing the updated input parameters are coded using the symbols of the description languages to form an updated output specification. The coded output specification is transmitted from the receiving unit to the sending unit. The sending unit decodes the received output specification into the abstract output elements containing the updated input parameter. At this stage the updated input parameters are available for processing at the sending unit.

Such embodiments are useful to allow a server computer to define the elements of a user interface in an abstract way, such that the user interface can be output on a variety of clients using client-specific output and input components. Examples of such clients comprise, but are not limited to, simple text terminals, HTML or web browsers, mobile devices using WAP browsers or short messaging services, audio devices, which are capable of synthesizing a voice, and devices having a graphical user interface.

The methods described can be used in a variety of different configurations of sending units and receiving units, typically connected using a common data network. The used data network only needs to provide means for transmitting output specifications in the provided description language. Thus any network protocol for example the transmission control protocol of the internet protocol (TCP/IP), the hypertext transfer protocol (HTTP), the remote method invocation (RMI) protocol, the simple object access protocol (SOAP) or the common object request broker architecture (CORBA) can be used for the transmission of the output specification.

The used description language can be based on open standards such as the extensible mark-up language (XML), whose symbols can be generated easily from a variety of programming languages, such as Java, C++, C#, Visual Basic, Perl or PHP, and tools. Thus the coding and the decoding of the output specification can be achieved using standard application programming interfaces (APIs) like the Document Object Model (DOM), the Simple API for XML (SAX) or the Java API for XML Processing (JAXP) or Binding (JAXB).

In cases, where the output specification is provided according to the XML standard, freely available software tools can be used to implement the mapping of abstract output elements to output components. Such tools are often based on other XML-related standards, for example the extensible stylesheet language for transformations (XSLT).

In another embodiment of the invention, a grammar describing the description language is used to verify the correctness of the coded output specification. In this way a client receiving an output specification can confirm that all symbols of the output specification are known to it, i.e., a successful completion of the task of outputting the contained data is possible. If the received output specification does not comply with the grammar known to the receiving unit, for example because the sending unit and the receiving unit use different variants or versions of the description language, or because the sending unit is malfunctioning, the receiving unit can reject the request to output the transmitted data. In this way, instead of starting to present it and terminating with an error once the incorrect or unknown parts of the output specification are reached, a malfunctioning of the receiver is prevented. Such a grammar can be specified for example using an XML Schema document or a Document Type Definition (DTD).

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention is explained in more detail below with reference to exemplary embodiments, where

FIG. 1 shows a system comprising an application, a sending unit and a receiving unit;

FIG. 2 shows an exemplary output specification;

FIG. 3 shows a block diagram of a first method for outputting data;

FIG. 4 shows a block diagram of a second method for outputting data;

FIG. 5 shows a first embodiment of a receiving unit;

FIG. 6 shows a second embodiment of a receiving unit;

FIG. 7 shows a HTML page generated from an abstract output specification;

FIG. 8 shows a graphical user interface generated from an abstract output specification.

### DETAILED DESCRIPTION

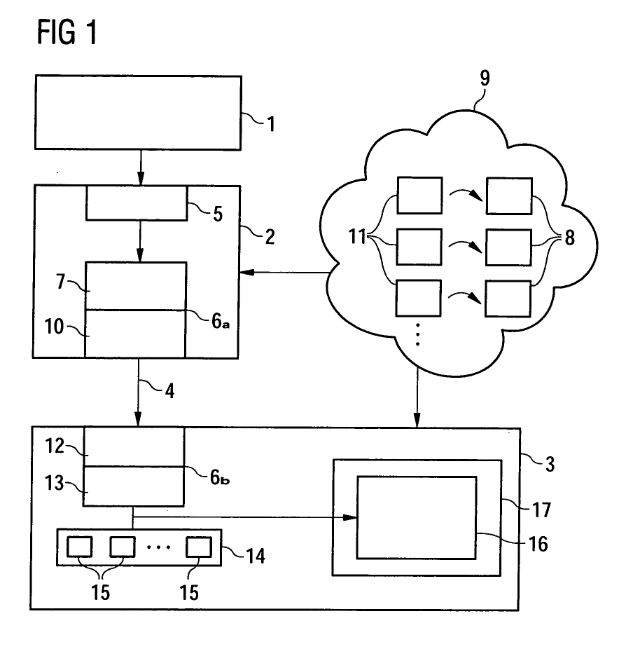

FIG. 1 shows a system comprising an application 1, a sending unit 2 and a receiving unit 3. The sending unit 2 and receiving unit 3 are connected by a network 4, e.g., the Internet, a company internal data network, a public switched telephone network (PSTN) or a dedicated communication line. The sending unit 2 comprises a data input 5, e.g., an application programming interface (API) accessible to the application 1, a physical device receiving data, like a modem, or a mechanism reading data from a storage medium like a hard-disk drive, and a data processing unit 6a, for example the central processing unit (CPU) of a server computer or a programmable logic unit like a field-programmable gate array (FPGA) or an application-specific integrated circuit (ASIC). The data processing unit 6a comprises a mapping unit 7, for example as a software process running in a CPU of a PC or a hardware device, which is part of the data processing unit 6. The processing unit 6 further comprises a coding unit 10, like an API of a standard library for the encoding of extensible markup language (XML) messages or a dedicated signal processor.

The receiving unit 3 comprises a data processing unit 6b, which in turn comprises a decoding unit 12 and a mapping unit 13. Again the decoding unit 12 or the mapping unit 13 can be implemented in either hardware or software. The receiving unit 3 also contains a library 14 of output components 15, e.g., text boxes, check boxes, radio buttons, menu elements, push buttons and etc. The output components 15 can be composed to form a user interface 16, like a graphical representation of a screen or read-out instruction for a user, on an output device 17 of the receiving unit 3, e.g., a built-in screen or a loudspeaker.

Both the sending unit 2 and the receiving unit 3 have access to a common description language 9, which comprises symbols 11 for the description of abstract output elements 8.

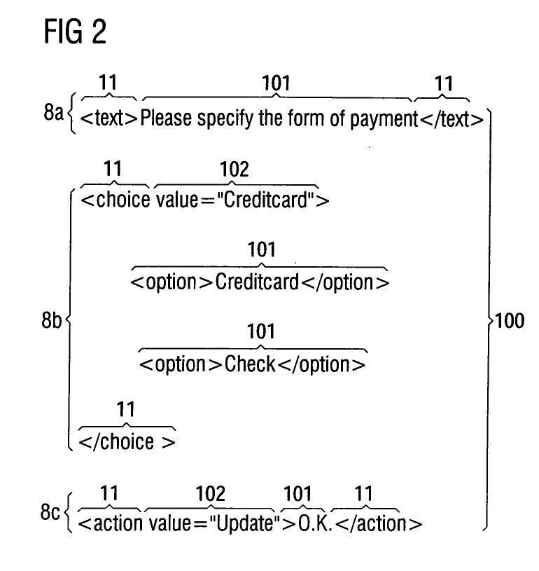

FIG. 2 shows an exemplary output specification 100. The associated description language 9 provides three abstract output elements 8, one called “abstract text” 8a used for outputting textual information, one called “abstract choice” 8b used to output a selection of exclusive options and return a user choice, and a last one called “abstract action” 8c used to specify a potential action, which can be activated using the user interface 16. Practical implementation of description languages 9 will of course offer more abstract output elements 8, such as menu items, input fields or hierarchical structures. Each abstract output element 8 is represented by a different symbol 11. In the example these symbols are “<text>”, “<choice>” and “<action>”. The elements also contain output data 101 and input parameters 102. For example, the abstract output element “abstract text” contains the text to be output. The abstract output element “abstract choice” specifies both output data 101, i.e., the options to be presented, and an input parameter 102, which specifies the option currently chosen represented by, e.g., a currently pressed radio-button in a graphical representation of the user interface 16.

In an exemplary embodiment of the invention the sending unit 2 is a server computer which runs the application 1, which provides data to be output on the user interface 16 of the receiving unit 3. In this example the application 1 prompts a user of the application 1 to make a choice between two different options, namely the payment by credit card or check. To this end, text is output on the output device 17 of the receiving unit 3. The user interface 16 also presents the choice between the two options and allows a user to choose one of them. Finally, the user interface 16 confirms the user's choice.

Whether the receiving unit 3 is a web browser or an automatic phone messaging service is not known to the sending unit 2 or the application 1.

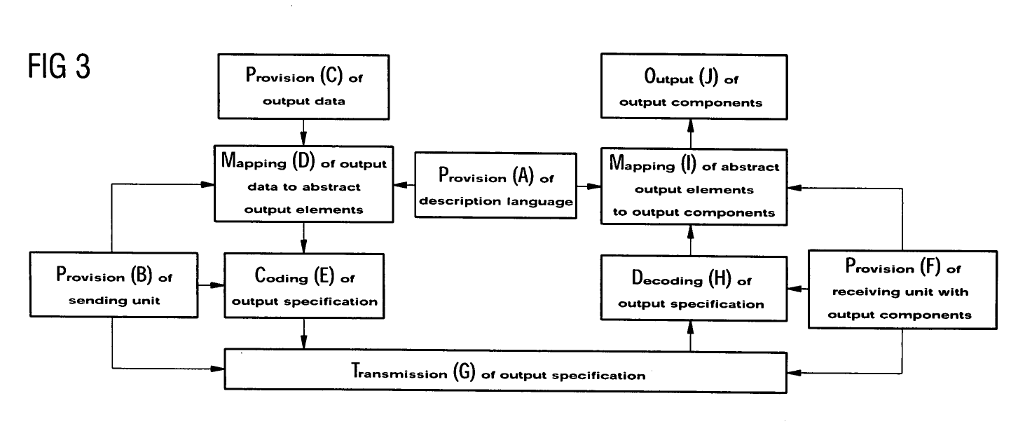

FIG. 3 shows individual procedures A-J of the inventive method. The arrows between the procedures indicate their logical dependency, but not necessarily a temporal order. The procedures will be described in detail using the example set out above.

The procedures A, B and C provide the description language 9; the sending unit 2 and the output data received from the data input 5 respectively. In this example, we will use an XML notation for the description language 9, whereby tag names denote the abstract output elements 8, their contained data is used to specify the output data 101 and attributes are used to specify the input parameters 102. An exemplary output specification 100 of the example language 9 is presented in FIG. 2. As sending unit 2, for example, a web-server can be used, which responds to requests from the client according to the hypertext transport protocol (HTTP) by providing a response message, in this example an output specification 100 like the one presented in FIG. 2. For the example it is assumed that the application 1 runs on the same computer which acts as the web-server, i.e., application 1 can provide output data via a software interface like an API. Of course this does not need to be the case in general, i.e., application and web-server can run on different machines and communicate in another way, e.g., by exchanging files over a data network.

In procedure D the output data is mapped to abstract output elements 8. In the example, one “abstract text” output element 8a for the output of the text “Please specify the form of payment” and one “abstract action” output element 8c for the confirmation of the choice are mapped to the output data provided. In addition, one “abstract choice” output element 8b comprising the options “Credit Card” and “Check” and an input parameter, which specifies that the “Credit Card” option is the currently chosen option, is mapped. In procedure E the sending unit 2 codes the output specification 100 of the desired user interface by replacing the abstract output elements 8 with their respective symbols 11 from the description language 9 and including the provided output data 101 and input parameters 102. In this example, this procedure results in the output specification shown 100 in FIG. 2, though this specification 100 is exemplary and neither the used symbols 11, their format or their order is limiting or prescriptive.

In procedure F a receiving unit 3 with a library 14 of specific output components 15 is provided. In the example chosen, the receiving unit 3 is a web browser, which is capable of displaying text documents complying with the HTML standard. Among others the HTML 4.0 specification provides output components 15 for displaying text, e.g., using the <p>-tag, an output component 15 to specify a form for user input, indicated by the <form>-tag and different output components 15 of the form, e.g., those specified using the <input>-tag. The output components 15 specified by the <input>-tag are parameterized using a “type” attribute with values like “submit” or “radio” to specify a special submit button, which triggers a special feedback mechanism, and a radio-button respectively. All of these language elements can be parameterized to further specify the exact properties and the format of these output components 15.

In procedure G the output specification 100 coded in procedure E is transmitted from the sending unit 2 to the receiving unit 3 using the network 4. In the example this transmission uses the HTTP protocol and is thus initiated by the receiving unit 3, i.e., via the web browser requesting a document from a predetermined web address. However, in general such a process could also be initiated by the sending unit 2, e.g., by broadcasting a coded output specification 100 to a group of receiving units 3 using the user datagram protocol (UDP). The receiving unit 3 decodes the received output specification 100 into the corresponding abstract output elements 8 in procedure G. In the following procedure I the abstract output elements 8 are mapped to output components 15 which are specific to the receiving unit 3 being used and the capabilities of its output device 17.

For the web browser of this example, the output components 15 correspond to the tags provided by the HTML standard and described above. Thus, in procedure I, abstract output elements 8 are mapped to the output components 15, which are the aforementioned HTML-tags in the given example. In this particular case, the procedures G and 1 can be combined.

In the example the decoding and mapping process can be affected by the use of a transformation language, as described for example by the extensible style sheet language (XSL) and its accompanying transformation language (XSLT) specifications, and corresponding transformation engines, which are capable of executing these transformation. For example, a resulting HTML document might look as follows:

<HTML>
<HEAD>
<TITLE>Please specify the form of payment</TITLE>
</HEAD>
<BODY>
<FORM action=“payment.html”>
<P> Please specify the form of payment</P>
<INPUT type=“radio” value=“Creditcard”
name=“choice1”>Creditcard<BR>
<INPUT type=“radio” value=“Check” name=“choice1”>Check<BR>
<INPUT type=“submit” value=“O.K.”>
</FORM>
</BODY>
</HTML>

In the example provided, the “abstract text” output element 8a, prompting the user to make a choice, is mapped to output components 15 both as paragraph displayed on the generated page and as the title for that page. The “abstract choice” output element 8b for choosing between the two different options of payment is mapped to a collection of radio-buttons. They belong to a common group, because they both specify the same name (“choice I” in the example). As a consequence, only one of these radio-buttons can be pressed at any one time as required by the semantic of the abstract output element 8b. The same information could have been mapped to a drop-down menu, which is also an available component of the HTML specification. The choice, of which output component 15 is to be used for the abstract output element 8b, rests with the receiving unit 3. The “abstract action” output element 8c of the example, which confirms the choice, is mapped to the special type of button provided by the HTML specification for this purpose.

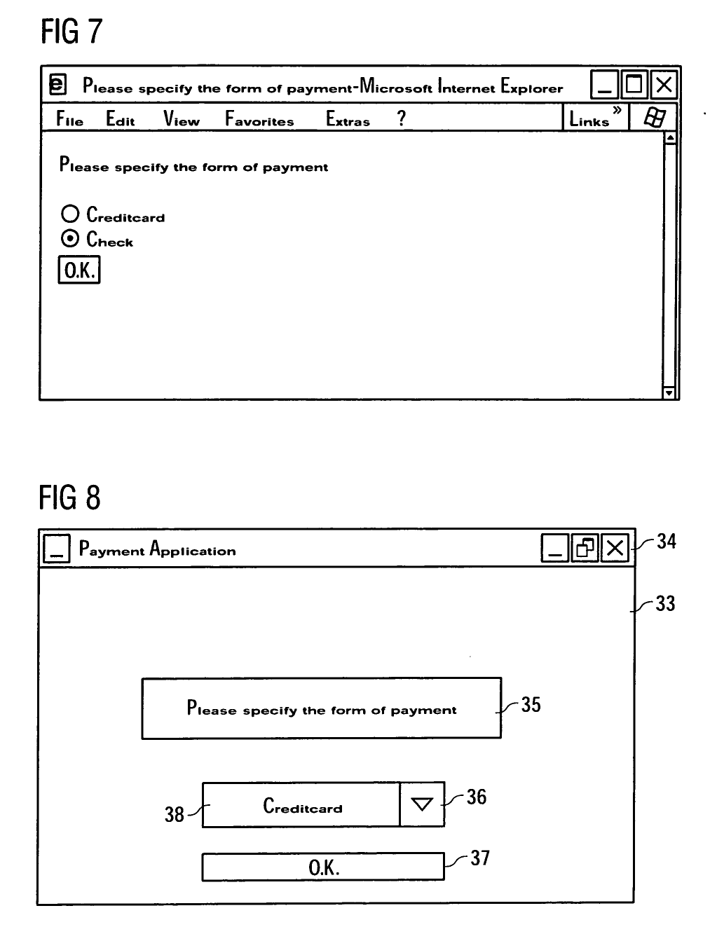

Together these HTML components specify the user interface 16. In a last procedure J, the user interface 16 is output via the output device 17 of the receiving unit 3. In the example provided, this procedure includes rendering of the HTML page shown above and displaying it in a window of the web browser. An exemplary result of this procedure is shown in FIG. 7.

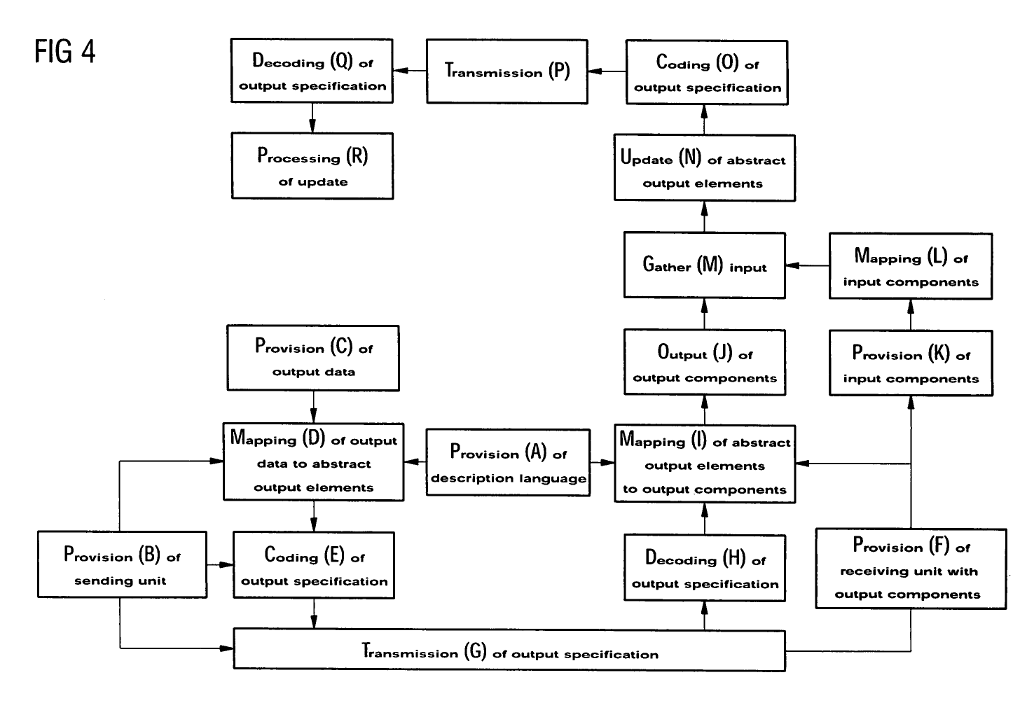

FIG. 4 shows another embodiment of the inventive method. The variant shown adds further procedures K-R in order to allow a feedback from the receiving unit 3 back to the sending equipment 2. In the example above, it is desirable to sent back the option chosen for the “abstract choice” output element 8b by a user after he or she has confirmed the choice by triggering the “abstract action” output element 8c, e.g., by pressing the “O.K.” button shown in FIG. 7.

The description language 9 provided in procedure A needs to comprise at least some abstract output elements 8, which contain at least one input parameter 102. The exemplary language used in the previous embodiment and the output specification of this language already provide such an abstract output element 8, namely the “abstract choice” output element 8b. It contains a single input parameter 102, which is represented by the attribute with the name “value”.

The procedures B-J are the same as in the embodiment described above. In procedure K, input components are provided, e.g., a pointing device such as a mouse with an associated mouse pointer on a graphical user interface, a touch-screen or a keyboard which allows characters to entered. These input components are mapped to the input parameters 102 of abstract output elements 8 with at least one input parameter 102 in procedure L. For example, an “abstract action” output element 8c with an associated button on a screen is associated with a mouse-click, or a text input field is associated with the input from a keyboard. In a procedure M the receiving unit 3 gathers input, for example a mouse-click within a predefined distance to an output component 15 displayed on a screen or a key-stroke of a particular key of a keyboard. In procedure N the gathered information is used to update the state of the mapped input parameters 102 and thus the state of the abstract output elements 8 comprising them. For example, the selection of an option of the “abstract choice” output element 8b in the example above updates the state of its “value” input parameter 102.

After confirming the changes, for example, by activation the “abstract action” output element 8c represented by the button, the updated abstract output elements 8 can be encoded using the description language 9 in procedure O. This results in an updated version of the output specification 100. For example, if the user has clicked on the radio-button representing a payment by Check, the value of the input parameter 102 “value” encoded in the “abstract choice” output element 8b of FIG. 2, would read “Check” instead of “Credit Card” now. In procedure P this updated output specification 100 is sent back from the receiving unit 3 to the sending unit 2, which decodes the received output specification 100 in procedure Q back into the abstract output elements 8. Thus the updated input parameters 102 of the abstract output elements 8 are available to the sending unit 2 and can be made available to the application 1 for further processing in procedure R.

There are two possible options regarding the content of the output specification 100 returned in procedure P. One can either return the complete output specification 100, containing all abstract output elements 8 that were transmitted in procedure G from the sending unit 2. Or one can only transmit those abstract output elements 8 with input parameters 102, whose input parameters 102 have been updated in procedure N of the inventive method. The former option is easier to implement, as the receiving unit 3 does not need to maintain a list of updates performed in procedure N. It will just serialize, i.e., encode, the state of all abstract output elements 8 into an output specification 100, once this is triggered by a predetermined action. However, the latter option, i.e., the transmission of incremental updates in procedure P is more efficient, as less data has to be transformed. This is particularly important in a system, where the bandwidth available between receiving unit 3 and sending unit 2 is limited.

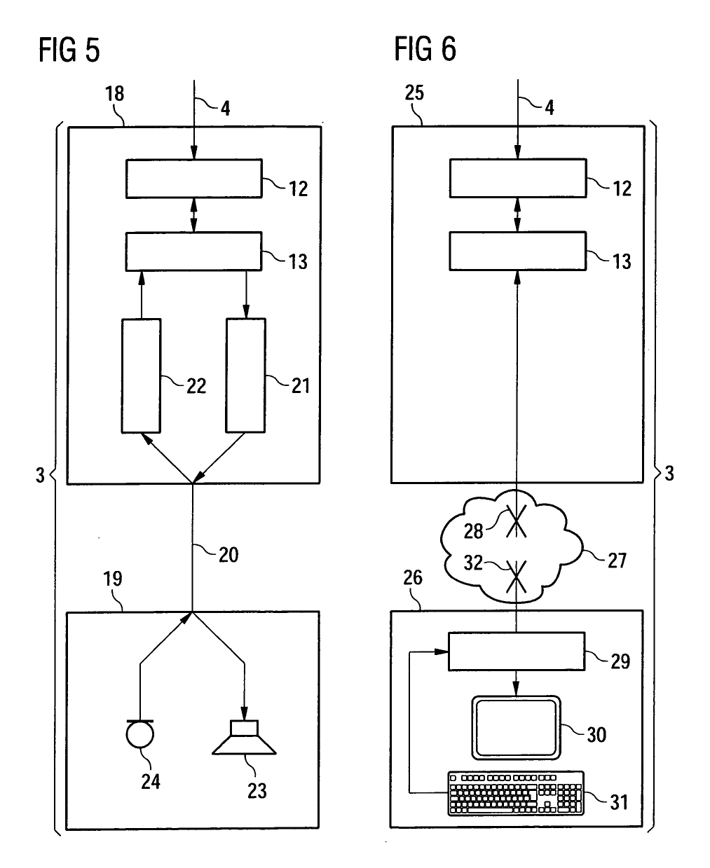

FIG. 5 shows another embodiment of the receiving unit 3 for the output of data. Herein the receiving unit 3 comprises an automatic voice system 18 and a telephone 19, which are connected by a telephone network 20. The automatic voice system 18 comprises a decoding unit 12, a mapping unit 13, a synthesizer 21 and a voice recognition system 22. The telephone 19 comprises a loudspeaker 23 and a microphone 24.

Procedures A to E, G and H, i.e., the provision (A, B, C) of the description language 9, the sending unit 2 and output data, the mapping D of output data to abstract language elements 8, the coding E of the output specification 100 and the transmission G and decoding H of the output specification 100 remain unchanged. The receiving unit 3 provided in procedure F comprises the automatic voice system 18 and the telephone 19. The automatic voice system 19 comprises the synthesizer 21, which, in combination with the telephone 19, provides the user interface 16 using the loudspeaker 23 as the output device 17. In procedure 1 the abstract language elements 8 are mapped to spoken commands, which correspond to the output components 15. The spoken commands are output on the loudspeaker 23 of the telephone 19 using the synthesizer 21 in procedure J of the inventive method. The audio signals generated from the synthesizer 21 are transmitted via the telephone network 20 to the telephone 19.

The separation of the receiving unit 3 into the automatic voice system 18 and the telephone 19 thereby allows the inventive method to be applied to an arbitrary telephone 19 using the public switch telephone network 20. Consequently the application 1 is accessible from any telephone 19 in the world. The automatic voice system 18 does not need to be in close proximity to the sending unit 2 or the telephone 19.

In order to implement a feedback path using the receiving unit 3 shown in FIG. 5, the microphone 24 is used in combination with the voice recognition system 22, which is provided in procedure K as input component. Here the mapping L of input components to input parameters 102 will be time-dependant, i.e., the voice recognition system 22 will always direct its output to the input parameter 102 of the abstract output element 8 being read out at that moment. For example, after reading a list of available options in procedure J to a user of the telephone 19, the user can react by speaking a command, e.g., by saying the number of the option he or she wishes to select. This information is gathered in procedure M via the microphone 24 and transmitted over the telephone network 20 back to the voice recognition system 22. In procedure N the voice recognition system 22 analyzes the received voice pattern and updates the input parameter 102 of the current abstract output element 8 with the corresponding value. Procedure O codes the updates information either immediately or after a confirmation or at the completion of the phone call and transmits it in procedure P back to the sending unit 2. As in above, the sending unit 2 decodes the updates output specification 100 containing the values of the input parameter 102 in procedure Q. In procedure R the values of the input parameters 102 are processed, e.g., by sending the values back to the application 1.

In another embodiment shown in FIG. 6, the receiving unit 3 comprises a messaging gateway 25, a mobile phone 26 and a mobile phone network 27. The messaging gateway 25 comprises a decoding unit 12 and a mapping unit 13 and is connected to a sending antenna 28. The mobile telephone 26 comprises a messaging unit 29, a screen 30 and a keyboard 31. The messaging unit 29 is connected to a receiving antenna 32. The messaging gateway 25 is able to transmit messages to the mobile telephone 26 using the mobile phone network 27.

Again the procedures A to E, G and H remain unchanged. The receiving unit 3 provided in procedure F comprises the mobile phone 26 and the messaging gateway 25. The screen 30 of the mobile phone 26 can be used as output device 17 of the receiving unit 3. In the procedure 1 the abstract language elements 8 are mapped to short textual descriptions, which act as output components 15. For example the output data 101 of the “abstract text” output element 8a can be used as its representation. The options of the “abstract choice” output element 8b can be represented, for example, as numbered entries of a list. The “abstract action” output element 8c can be mapped to a predefined function key of the mobile phone 26, e.g., a special “O.K.” button of the keyboard 31. The textual descriptions are combined to form a short message which is transmitted over the sending antenna 28 and the network 27 to the receiving antenna 32 of the mobile phone 26. In the procedure J the received short message comprising the user interface 16 is displayed on the screen 30 of the mobile phone 26.

This embodiment of the invention makes the application 1 available to all mobile -phones 26 using a short messaging service. Because the mapping unit 13 provided by the messaging gateway 25 is separate from the receiving mobile phone 26, the embodiment can be used with existing mobile phones 26. The messaging gateway 25 can be provided as a service directly provided by the sending unit 2 or as an independent unit. In the latter case it is possible to use the messaging gateway 25 with several sending units 2 each providing one or more applications 1.

The embodiment of the receiving unit 3 presented in FIG. 6 can also be used to implement a feedback path. Herein the keyboard 31 is used as an input component, which is provided in procedure K. In procedure L individual keys are mapped to the input parameters 102 of the abstract output elements 8. Alternatively a cursor can be used on the screen 30 of the mobile phone 26. The cursor is controlled by a special group of keys of the keyboard 31 of the mobile phone 26, as they are commonplace. The input from the other keys is then directed to the output component 15 at the current position of the cursor.

In procedure M such input from the keyboard 31 is gathered by the mobile phone 26. For example, a user might select an option from a numbered list on the screen by pressing the number key corresponding to the selected option. In procedure N this information is used to update the input parameter 102 of the corresponding abstract output element 8, i.e., the input parameter 102 of the “abstract choice” output element 8b.

Once the changes have been confirmed, e.g., by pressing a special “O.K.” key on the keyboard 31 of the mobile phone 26, the updated abstract output elements 8 are encoded to form an updated output specification in procedure O. This can be done, for example, by composing a new message containing an updated output specification 100 using the messaging unit 29, which is send back to the messaging gateway 25 and passed on to the sending unit 2 in procedure P. Alternatively only the input signals are send back to the messaging gateway 25 and the procedures N-P, i.e., the updating of the abstract output element 8, the coding of an updated output specification 100 and the transmission of the output specification 100 are performed by the messaging gateway 25. The transmitted message comprising the updated output specification 100 is decoded in procedure Q and processed in procedure R by the sending unit as in the other embodiments above.

Of course the inventive method can also be used for defining the output of a locally run application 1. In a further exemplary embodiment of the invention a single PC comprises the sending unit 2 and the receiving unit 3. In this embodiment the inventive method is used in order to separate the code defining the application logic from the code defining its user interface 16, e.g., using a graphical user interface (GUI) class library. An exemplary library, which can be used as library 14 of output components 15, is the Java Swing class library. In this case the Swing class library acts as the library 14 of output components 15, which are provided in form of Swing components, e.g., JButtons, JMenus and so on.

FIG. 8 shows a GUI window 33 generated from the output specification 100 shown in FIG. 2. It comprises a title bar 34 comprising system specific elements, such as the application name (in the example “Payment Application”) and button for closing the window 33 or resizing it. In addition, the window 33 comprises a number of output components 15. In the example these are a text pane 35, a drop-down menu 36 and a push button 37. They correspond to the abstract output elements 8a, 8b and 8c of the output specification 100 respectively. In the example given, they could be implemented using a JTextPane, a JMenu with two JMenuItems and a JButton of the Java Swing library. The JMenuItems correspond to the different options of the “abstract choice” output element 8b, with the currently visible menu item 38 being the current value of the associated input parameter 102 of the abstract output element 8b.

Of course other output components 15 of the same class library 14 could have been used for the generation of the user interface 16. The Java Swing library also provides radio-buttons, i.e., JRadioButtons, which could have been used to implement the “abstract choice” output element 8b. In addition, a completely different class library could have been used. Older versions of the Java Class library, predating the Swing library, use the Abstract Window Toolkit (AWT) to generate GUIs. A mapping of the abstract output elements 8 to output components 15 of this library can be performed in a similar way as described above. Many other programming languages and environments also provide class libraries 14 with output elements 15 for the construction of GUIs, which can be employed in a similar fashion. A not limiting list of such class libraries comprises: the NET class library, the XWindow class library, the Qt class library, the Tcl/Tk class library and the Motif class library.

Using the inventive method the time-consuming task of defining a GUI for outputting data is avoided and replaced by the automatic generation of concrete output components 15, given, for example, by system specific class libraries 14, from a abstract output specification 100.

While the invention has been described in detail and with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

### LIST OF REFERENCES

1. Application
2. Sending unit
3. Receiving unit
4. Network
5. Data input
6. Data processing unit
7. Send mapping unit (of the sending unit)
8. Abstract output elements
9. Description language
10. Coding unit
11. Symbol
12. Decoding unit
13. Receive mapping unit (of the receiving unit)
14. Library
15. Output components
16. User interface
17. Output device
18. Automatic voice system
19. Telephone
20. Telephone network
21. Synthesizer
22. Voice recognition system
23. Loudspeaker
24. Microphone
25. Messaging gateway
26. Mobile phone
27. Mobile phone network
28. Sending antenna
29. Messaging unit
30. Screen
31. Keyboard
32. Receiving antenna
33. Window
34. Title bar
35. Text pane
36. Drop-down menu
37. Push-button
38. Menu item
100. Output specification
101. Output data
102. Input parameter
A-R Procedures of the methods for outputting data

What is claimed is:

1. A method for outputting data comprising:
providing a description language comprising symbols that represent abstract output elements for output data;
providing a sending unit;
providing data to be output;
mapping output data to abstract output elements;
coding abstract output elements to an output specification via symbols of the description language;
providing a receiving unit including output components specific to the receiving unit;
transmitting the output specification from the sending unit to the receiving unit;
decoding the output specification into the abstract output elements of the description language via the receiving unit;
mapping the abstract output elements to the output components specific to the receiving unit; and
outputting the mapped output components.

2. The method of claim 1, wherein the description language further comprises abstract output elements including input parameters, and the method further comprises:
providing input components specific to the receiving unit;
mapping the input components to decoded input parameters via an input parameter;
gathering input values via the input components;
updating the input parameters via the gathered input values;
coding the mapped abstract output elements with an updated input parameter into an updated output specification using symbols of the description language via the receiving unit;
transmitting the updated output specification from the receiving unit to the sending unit;
decoding the updated output specification into the abstract language elements with updated input parameters of the description language; and
processing the abstract output elements with updated input parameters.

3. The method of claim 1, wherein the abstract output elements describe components of a user interface.

4. The method of claim 1, wherein the receiving unit is configured to output text, and the mapping of abstract output elements to the output components specific to the receiving unit includes mapping of character sequences to the decoded abstract output elements.

5. The method of claim 1, wherein the receiving unit is configured to output pages according to HTML specification, and the mapping of abstract output elements to the output components specific to the receiving unit includes mapping of components to the decoded abstract output elements according to HTML specification.

6. The method of claim 1, wherein the receiving unit is configured to output audio signals, and the mapping of abstract output elements to the output components specific to the receiving unit includes mapping of audio signals to the decoded abstract output elements.

7. The method according to claim 1, wherein the receiving unit is configured to display a graphical user interface, and the mapping of abstract output elements to the output components specific to the receiving unit includes mapping of graphical components for the composition of a graphical user interface to the decoded abstract output elements.

8. The method of claim 7, wherein the graphical components are provided via at least one class library of the receiving unit.

9. The method of claim 8, wherein the at least one class library is selected from the group consisting of Java AWT, Java Swing, net, XWindow, Qt, Tcl/TK, and Motif.

10. The method of claim 2, wherein the updated output specification is transmitted via a data network and at least one network communication protocol.

11. The method of claim 10, wherein the at least one network communication protocol is selected from the group consisting of TCP/IP, HTTP, RMI, SOAP, and CORBA.

12. The method of claim 1, wherein the description language is described by a grammar that verifies accuracy of the transmitted output specification.

13. The method of claim 12, wherein the description language complies with an extensible mark-up language (XML) format and the grammar complies with at least one format selected from the group consisting of Document Type Definition (DTD) and extensible mark-up language (XML) Schema.

14. The method of claim 1, wherein one of the mapping of output data to abstract output elements and the mapping of abstract output elements to the output components specific to the receiving unit is performed using a scripting language.

15. The method of claim 14, wherein the scripting language is at least one of the scripting languages selected from the group consisting of XSLT, ECMA-Script, JScript, PHP, and Perl.

16. The method of claim 1, wherein one of the mapping of output data to abstract output elements and the mapping of abstract output elements to the output components specific to the receiving unit is performed via a programmable hardware device.

17. The method of claim 16, wherein the programmable hardware device comprises at least one component selected from the group consisting of ASIC, PAL, GAL, and an FPGA device.

18. A sending unit comprising:
a module storing a description language including symbols providing a description of abstract output elements for the outputting of data;
a data input to receive data;
a mapping unit that maps data received from the data input to abstract output elements of the description language; and
a coding unit that generates output specifications comprising symbols of the mapped abstract output elements of the description language;
wherein the sending unit transmits the composed output specifications.

19. A receiving unit comprising:
an input device that receives an output specification comprising symbols of a description language;
a module storing the description language including symbols providing a description of abstract output elements for outputting of data;
a library of output components specific to the receiving unit;
a decoding unit that decomposes output specifications into abstract output elements of the description language;
a mapping unit that maps decoded abstract output elements to the output components; and
an output device that outputs the mapped output components.

20. A system comprising:
a sending unit comprising:
a module storing a description language including symbols providing a description of abstract output elements for the outputting of data;
a data input to receive data;
a mapping unit that maps data received from the data input to abstract output elements of the description language; and
a coding unit that generates output specifications comprising symbols of the mapped abstract output elements of the description language;
wherein the sending unit transmits the composed output specifications;
a receiving unit comprising:
an input device that receives an output specification comprising symbols of a description language;
a module storing the description language including symbols providing a description of abstract output elements for outputting of data;
a library of output components specific to the receiving unit;
a decoding unit that decomposes output specifications into abstract output elements of the description language;
a mapping unit that maps decoded abstract output elements to the output components; and
an output device that outputs the mapped output components; and
a communication network that connects the sending unit to the receiving unit.
